(19) United States
(12) Patent Application Publication
(10) Pub. No.: US 2009/0129605 A1
(43) Pub. Date: May 21, 2009

(54) Apparatus and methods for augmenting a musical instrument using a mobile terminal

(75) Inventors: William O. Camp, JR., Chaple Hill, NC (US); William Chris Eaton, Cary, NC (US); Paul Leonard Futter, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/947,270

(22) Filed: Nov. 29, 2007

Related U.S. Application Data
(60) Provisional application No. 60/988,279, filed on Nov. 15, 2007.

(51) Int. Cl. H04B 7/00; H04B 3/00

(52) U.S. Cl. 381/77; 455/66.1

(57) ABSTRACT

A mobile communications terminal for augmenting a musical instrument includes an audio signal receiver that is configured to receive an audio signal from the musical instrument and a signal processor that is configured to perform a signal processing function on the audio signal. The mobile communications terminal includes an audio signal transmitter that is configured to transmit the audio signal to an audio signal rendering device.

### RELATED APPLICATION

This application claims the benefit of and priority to U.S. Provisional Patent Application No. 60/988,279, filed Nov. 15, 2007, the disclosure of which is hereby incorporated herein by reference as if set forth in its entirety.

### BACKGROUND

The present invention relates to the field of electronic devices in general and, more particularly, to mobile communication terminals.

Mobile communication terminals, such as cellular telephones, are being equipped with increasingly varied features. For example, in addition to some long-range communication capabilities, such as cellular communication, some mobile terminals are configured to provide other communication options. Such communication options include short-range communication with other networks, such as local-area-networks, using wired and/or wireless access points. For example, mobile terminals can access network resources using WiFi, which is a short-range communication standard defined under IEEE 802. In addition to accessing local proximity based resources, mobile terminals may include additional functionality. For example, pre-recorded music may be stored and/or played using mobile terminals. Live music, however, may require specialized equipment for storing, sharing, combining and/or collaborating.

### SUMMARY

Embodiments of the present invention provide apparatus and methods for augmenting a musical instrument via a mobile communications terminal. Some embodiments of such methods include receiving an audio signal from the musical instrument into a mobile communications terminal and transmitting the audio signal to an audio signal receiving device via a communications link.

In some embodiments, receiving the audio signal includes receiving the audio signal into a microphone in the mobile communications terminal and transmitting the audio signal includes transmitting the audio signal via a wireless communications link.

In some embodiments, receiving the audio signal includes receiving an analog audio signal via a signal generator that is coupled to the musical instrument and configured to convert acoustic energy generated by the musical instrument into the analog audio signal and converting the analog audio signal into a digitized audio signal.

Some embodiments include, before transmitting the audio signal, modifying the audio signal via a data processing module in the mobile communications terminal. In some embodiments, modifying the audio signal includes applying an audio effect to the audio signal. In some embodiments, modifying the audio signal includes adjusting a frequency of the audio signal.

Some embodiments include generating a frequency specific audio output that is configured to provide a tuning reference tone for tuning the musical instrument.

In some embodiments, transmitting the audio signal to an audio signal receiving device includes transmitting the audio signal to an audio output device that is configured to output the audio signal. In some embodiments, transmitting the audio signal to an audio output device includes transmitting the audio signal to one or more speakers via an audio signal amplifier.

Some embodiments include internally generating a tuning reference value corresponding to a specific frequency, comparing a designated component of the audio signal to the tuning reference value to determine a tuning state of the musical instrument and communicating tuning information to a user corresponding to the tuning state.

Some embodiments of the present invention also include mobile communications terminals for augmenting a musical instrument. A mobile communications terminal according to some embodiments includes an audio signal receiver that is configured to receive an audio signal from the musical instrument, a signal processor that is configured to perform a signal processing function on the audio signal and an audio signal transmitter that is configured to transmit the audio signal to an audio signal rendering device. In some embodiments, the audio signal rendering device may include at least one audio speaker.

In some embodiments, the audio signal transmitter includes a wireless transmitter that is configured to wirelessly transmit the audio signal to the audio signal rendering device. In some embodiments, the signal processing function includes a modification of at least one frequency of the audio signal corresponding to a defined musical notation system. In some embodiments, the signal processing function includes an audio effect that is configured to alter and/or supplement a waveform of the audio signal.

In some embodiments, the signal processing function includes an equalizing function that is configured to adjust relative gain levels corresponding to a multiple frequency bands. Some embodiments include a display that is configured to display a user interface corresponding to augmenting the musical instrument. In some embodiments, the user interface may be configured to display musical notation corresponding to music that is configured to be played on the first instrument. In some embodiments, the user interface may be configured to display played musical notation responsive to the audio signal.

Some embodiments include an audio signal analyzer that is configured to analyze the audio signal and generate musical notation data corresponding to the audio signal. Some embodiments include a remote audio signal receiver that is configured to receive a remote audio signal corresponding to a remotely located musical instrument and an audio signal combiner that is configured to combine the audio signal and the remote audio signal to generate a composite audio signal such that the audio signal transmitter is configured to transmit the composite audio signal. In some embodiments, the audio signal receiver includes a microphone that is configured to receive the audio signal via acoustic energy generated by the musical instrument.

Some embodiments of the present invention include methods of cooperatively combining outputs from musical instruments via a mobile communications terminal. Some embodiments of such methods may include wirelessly receiving a first audio signal into a signal processing device from a first musical instrument via a first mobile communications terminal using a first communications link, receiving a second audio signal from a second musical instrument into the signal processing device, combining the first audio signal and the second audio signal into a composite audio signal, and transmitting the composite audio signal to an audio signal receiving device via a second communications link.

In some embodiments, the signal processing device includes a second mobile communications terminal and transmitting the composite audio signal includes transmitting the composite audio signal to the first mobile communications terminal. Some embodiments may include transmitting the composite audio signal from the first mobile communications terminal to a first audio output device that is proximate the first mobile communications terminal and transmitting the composite audio signal from the second mobile communications terminal to a second audio output device that is proximate the second mobile communications terminal. Some embodiments may include modifying the first audio signal responsive to the second audio signal before combining the first audio signal and the second audio signal. Some embodiments may include modifying the first audio signal responsive to user inputs received via at least one of the first or second mobile communications terminals.

Some embodiments include displaying, via the first mobile communications terminal, musical notation corresponding to music that is configured to be played on the first instrument. Some embodiments may include generating, via the first communications terminal, played musical notation responsive to the first audio signal, the second audio signal and/or the composite audio signal. In some embodiments, the composite audio signal may be broadcast via a network to multiple audio output devices. In some embodiments, wirelessly receiving the first audio signal includes receiving the first audio from a long range wireless transmitter.

Some embodiments of the present invention include methods of forming a musician group using mobile communications terminals. Some embodiments of such methods may include receiving multiple audio signals from multiple instruments via multiple mobile communications terminals, combining the audio signals into a composite audio signal and determining a first characteristic of the composite audio signal. Some embodiments of methods may further include adjusting the first characteristic of at least one of the audio signals relative to the first characteristic of the composite audio signal and transmitting the composite audio signal to the mobile communications terminals.

In some embodiments, determining the first characteristic of the composite audio signal includes determining a first characteristic range that includes a first upper limit and a first lower limit and adjusting the first characteristic includes adjusting ones of the audio signals relative to the first characteristic of the composite audio signal that have the first characteristic greater than the first upper limit or less than the first lower limit to be within the first characteristic range.

Some embodiments may include determining a second characteristic of the composite audio signal and adjusting the second characteristic of at least one of the audio signals relative to the second characteristic of the composite audio signal. In some embodiments, the first characteristic includes frequency and the second characteristic includes at least one note start and/or stop time. Some embodiments may include transmitting the audio signals to the mobile communications terminals.

Some embodiments may include receiving rating data from a portion of the mobile communications terminals corresponding to a quality rating of ones of the audio signals. Some embodiments may include compiling the rating data to rank the audio signals and selectively eliminating at least one of the audio signals from the composite signal responsive to compiled rating data.

Some embodiments may include displaying, via at least one of the mobile communications terminals, musical notation corresponding to music that is configured to be played on at least one of the instruments. In some embodiments, played musical notation responsive to a least one of the audio signals and/or the composite audio signal may be generated via a least one of the mobile communications terminals. Some embodiments may include broadcasting the composite audio signal via a network to multiple audio output devices.

### BRIEF DESCRIPTION OF THE DRAWINGS

FIG. 1 is a block diagram illustrating an apparatus for augmenting a musical instrument using a mobile communications terminal in accordance with some embodiments of the present invention.

FIG. 2 is a block diagram illustrating a mobile terminal used for augmenting a musical instrument in accordance with some embodiments of the present invention.

FIG. 3 is a block diagram illustrating a mobile terminal used in a telecommunications network for augmenting a musical instrument in accordance with some embodiments of the present invention.

FIG. 4 is a block diagram illustrating a mobile terminal used for augmenting a musical instrument in accordance with some embodiments of the present invention.

FIG. 5 is a block diagram illustrating a mobile terminal using wireless communications for augmenting a musical instrument in accordance with some embodiments of the present invention.

FIG. 6 is a block diagram illustrating a network of mobile terminals for cooperatively combining musical instruments in accordance with some embodiments of the present invention.

FIG. 7 is a block diagram illustrating a display of a mobile terminal that is used for augmenting a musical instrument in accordance with some embodiments of the present invention.

FIG. 8 is a block diagram illustrating a display of a mobile terminal that includes functions for cooperatively combining musical instruments in accordance with some embodiments of the present invention.

FIG. 9 is a flow diagram illustrating operations for augmenting a musical instrument using a mobile communications terminal in accordance with some embodiments of the present invention.

FIG. 10 is a flow diagram illustrating operations for augmenting a musical instrument using a mobile communications terminal in accordance with some embodiments of the present invention.

FIG. 11 is a flow diagram illustrating operations for cooperatively combining outputs from musical instruments via a mobile communications terminal in accordance with some embodiments of the present invention.

FIG. 12 is a flow diagram illustrating operations for cooperatively combining outputs from musical instruments via a mobile communications terminal in accordance with some embodiments of the present invention.

FIG. 13 is a flow diagram illustrating operations for forming a musician group using mobile communications terminals in accordance with some embodiments of the present invention.

FIG. 14 is a flow diagram illustrating operations for forming a musician group using mobile communications terminals in accordance with some embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some embodiments of the invention may arise from the recognition that mobile communications terminals may include functionality that may be used to augment musical instruments. In this manner, audio signals generated by musical instruments may be transmitted, stored, shared, modified, improved upon and/or combined with one another using mobile communications terminals and/or communications networks.

A mobile communications terminal (“mobile terminal”) may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

Mobile terminals may communicate with base station transceivers using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA (WCDMA), CDMA2000, and/or Universal Mobile Communications System (UTMS). Some mobile terminals may be called “multi-mode” mobile terminals because they're capable of communication using more than one cellular communication protocol. Within a single cellular communication protocol, a mobile terminal may be capable of transmitting and receiving over multiple frequency bands. For example a wireless terminal may be able to operate over the GSM850 band that is used in the United States (also referred to herein as GSM), the EGSM900 band that is used in Europe (also referred to herein as EGSM), the DCS1800 and that is used in Europe (also referred to herein as DCS) and the PCS1900 band that is used in the United States (also referred to herein as PCS).

As used herein, a “musical instrument” may include any of a variety of musical instruments including, but not limited to, stringed instruments such as, for example, guitars, wind (air) operated instruments, keyboard instruments, electronic instruments, percussion instruments and/or vocalists, among others.

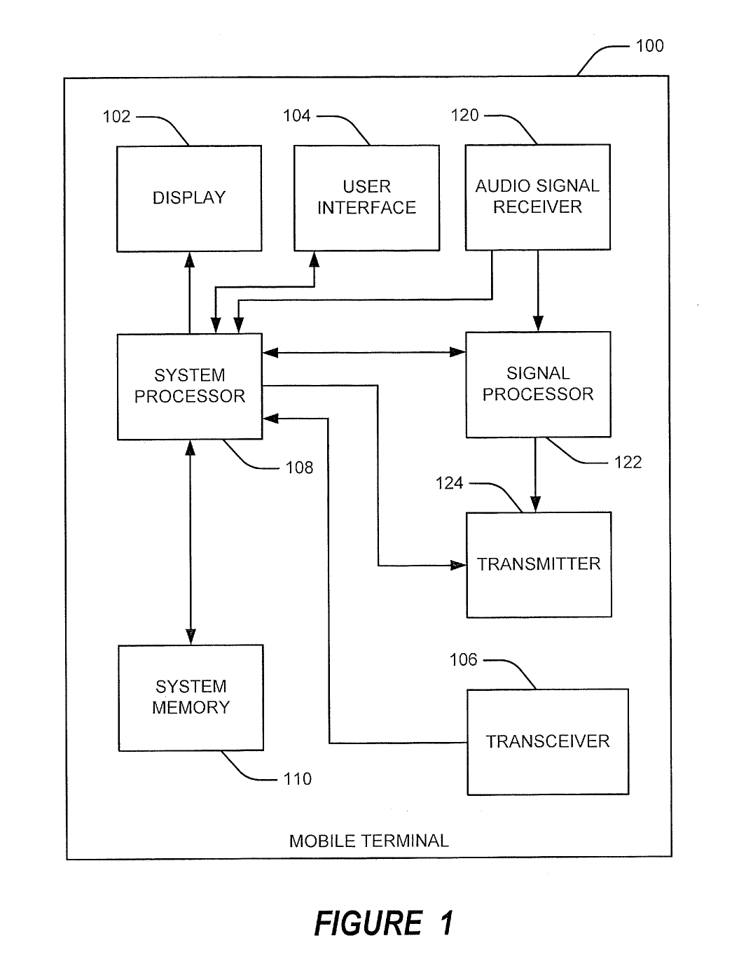

Reference is now made to FIG. 1, which is a block diagram illustrating an apparatus for augmenting a musical instrument using a mobile communications terminal in accordance with some embodiments of the present invention. A mobile terminal 100, in accordance with the some embodiments of the present invention, includes a user interface 104, a display 102, a transceiver 106, and a memory 110 that communicate with a processor 108. The transceiver 106 includes at least one transceiver circuit that maybe configured to transmit outgoing radio frequency signals to base station transceivers (not shown) via an antenna. The radio frequency signals transmitted between the mobile terminal 100 and the base station transceivers may comprise both traffic and control signals, which are used to establish and maintain communication with another party or destination. In accordance with various embodiments of the present invention, the mobile terminal 100 may communicate with a station transceivers using one or more cellular communication protocols.

The foregoing components of the mobile terminal 100 may be included in many conventional mobile terminals and their conventional functionality is generally known to those skilled in the art. Accordingly, only operations and components related to embodiments of the present invention will be described further herein.

The mobile terminal 100, according to some embodiments of the present invention, includes an audio signal receiver 120, a signal processor 122, and a transmitter 124. The audio signal receiver 120 is configured to receive an audio signal from a musical instrument into the mobile terminal 100. In some embodiments, the audio signal receiver 120 may include a microphone in the mobile terminal 100 that is configured to receive the audio signal via acoustic energy generated by the musical instrument. In some embodiments, the audio signal receiver 120 may include an electrical, capacitive and/or conductive connection configured to receive the audio signal via a signal generator that is coupled to the musical instrument and is configured to convert acoustic energy generated by the musical instrument into, for example, an analog audio signal. In some embodiments, the audio signal receiver 120 may be configured to receive the audio signal via a signal generator that is coupled to the musical instrument and configured to transmit the audio signal via radio frequency using, for example, a near field communication (NFC) protocol, Bluetooth, and/or Wifi, among others. In some embodiments, the mobile terminal 100 may also include signal format conversion circuitry such as, for example, an analog-to-digital converter, among others.

The received audio signal may be modified by the signal processor 122. In some embodiments, the audio signal may be modified in form and/or format for a variety of subsequent uses. For example, the audio signal may be modified for storage in memory 110 and/or other data storage locations. In some embodiments, the signal processor 122 may apply a special audio effect to the audio signal. For example, the pitch (frequency) and/or start and/or stop times of one or more notes in the audio signal may be modified. In this manner, the audio signal may be dynamically tuned for example. In some embodiments, special audio effects such as, for example, reverberation and/or vibrato, among others may be applied. In some embodiments, the audio signal may be modified and/or supplemented to include special audio effects such as harmonics, noise and/or signal distortion components. In this manner, the audio signal may be modified to mimic styles and/or properties of music generated by other musicians.

In some embodiments, the transmitter 124 may be configured to transmit the audio signal via a communications link. For example, the transmitter may transmit the audio signal to an audio signal receiving device via a wireless communications link using, for example, short range wireless techniques such as near field communication, Wifi and/or Bluetooth, among others. In some embodiments, the transmitter 124 may be configured to transmit the audio signal to the audio signal receiving device via a wire using an optical, conductive, inductive and/or capacitive coupling. In some embodiments, the transmitter 124 includes a speaker mounted within the mobile terminal 100 that is configured to transmit the audio signal as acoustic energy. Although illustrated as a separate component from the transceiver 106, the transmitter 124 may be integrated with the transceiver 106 and, in some embodiments, be configured to transmit the audio signal via long-range communications to, for example, a remotely located audio signal receiving device.

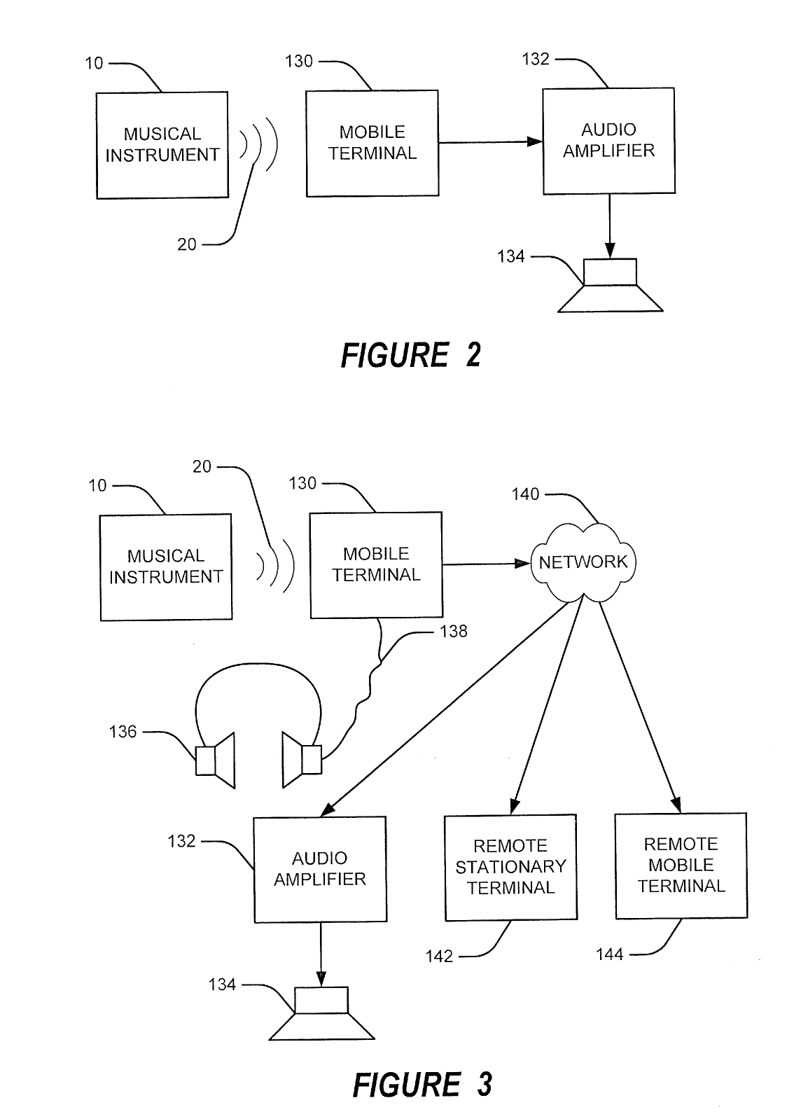

Reference is now made to FIG. 2, which is a block diagram illustrating a mobile terminal used for augmenting a musical instrument in accordance with some embodiments of the present invention. A mobile terminal 130 is configured to receive an audio signal 20 in the form of acoustic energy from a musical instrument 10. The mobile terminal 130 transmits the audio signal 20 to an audio amplifier 132, which is configured to amplify the audio signal 20 and drive an audio output device 134. In this manner, the mobile terminal 130 can receive the audio signal 20 from the musical instrument 10 and transmit the audio signal 20 to an audio amplifier 132 without any musical instrument specific equipment.

Reference is now made to FIG. 3, which is a block diagram illustrating a mobile terminal used in a telecommunications network for augmenting a musical instrument in accordance with some embodiments of the present invention. A mobile terminal 130 is configured to receive an audio signal 20 in the form of acoustic energy from a musical instrument 10. In some embodiments, the mobile terminal 130 may transmit the audio signal to a proximate user via, for example, personal speakers 136, which may include, for example, an electrically conductive coupling 138 to the mobile terminal 130.

In some embodiments, the mobile terminal 130 transmits the audio signal 20 to a network 140, through which the audio signal 20 may be disseminated to a variety of devices and/or locations. The network 140 may include any combination of a variety of networks including, for example, wireless and/or wired communication networks, data networks, local area networks (LAN), wide area networks (WAN), Internet and/or intranet, among others.

In some embodiments, the network 140 may be connected to an audio amplifier 132, which may be configured to amplify an audio signal 20 to drive one or more audio output devices 134, such as, for example, speakers. In some embodiments, the audio signal 20 may be received via the mobile terminal 130 and the network 140 by a remote and/or local stationary terminal 142, such as, for example, a desktop, personal and/or server based data processing and/or computing device. In this regard, the remote stationary terminal 142 may play the audio signal 20 that is generated by the musical instrument 10 in a location that is remote from the musical instrument 10.

In some embodiments, the audio signal 20 may be received via the mobile terminal 130 and the network 140 by a remote mobile terminal 144. The remote mobile terminal 144 may be configured to provide an output corresponding to the audio signal. For example, a guitar may be played proximate the mobile terminal 130 in a first city such that the mobile terminal 130 receives the audio signal 20 corresponding to the guitar music. The audio signal 20 may be transmitted via the network to a mobile terminal in a second city that may be coupled to an audio signal receiving device, which may be configured to provide an audio output of the guitar music in the second city. In this manner, the musical instrument may be augmented by the mobile terminal.

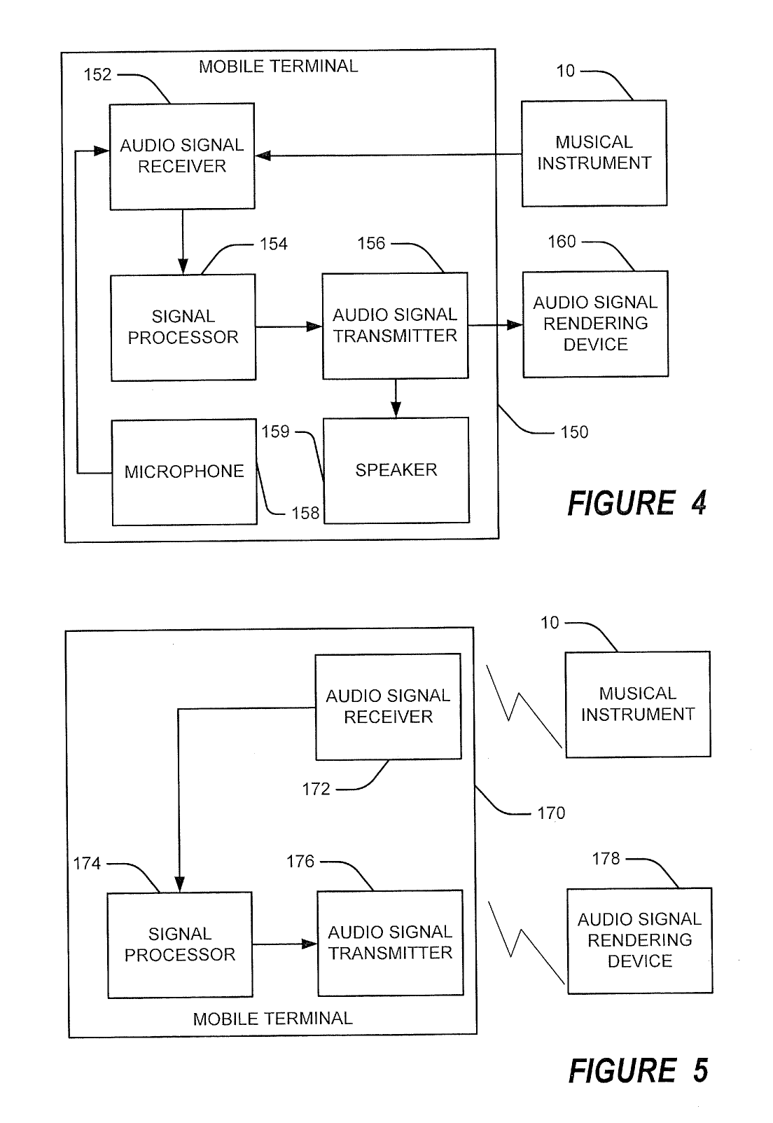

Reference is now made to FIG. 4, which is a block diagram illustrating a mobile terminal used for augmenting a musical instrument in accordance with some embodiments of the present invention. A mobile terminal 150 includes an audio signal receiver 152 that is configured to receive an audio signal from a musical instrument 10. In some embodiments, the audio signal receiver 152 may receive the audio signal in the form of an electrical signal that may be generated by a signal converter attached to the musical instrument. For example, a signal converter, such as a guitar pick-up transducer, may be configured to convert acoustic energy generated by the musical instrument into an analog and/or digital signal. In some embodiments, the signal converter may be a microphone that is attached to and/or is integral with the musical instrument. In some embodiments, the audio signal receiver 152 may utilize and/or include a microphone 158 that is within the mobile terminal 150 to receive the audio signal as acoustic energy.

The mobile terminal 150 may include a signal processor 154 that is configured to modify and/or convert the received audio signal. In some embodiments, the audio signal may be modified and/or converted in form and/or format for a variety of subsequent uses. For example, the audio signal may be modified for storage in one or more data storage locations. In some embodiments, the signal processor 154 may apply a special audio effect to the audio signal. For example, the pitch (frequency) and/or start and/or stop times of one or more notes in the audio signal may be modified. In this manner, the signal processor 154 may improve the tuning and/or timing of the musical content in the audio signal. In some embodiments, special audio effects such as, for example, reverberation and/or vibrato, among others may be applied. In some embodiments, the audio signal may be modified and/or supplemented to include special audio effects such as harmonics, noise and/or signal distortion components. In this manner, the audio signal may be modified to mimic styles and/or sounds of, for example, other musicians. In some embodiments, the signal processor 154 may include modification templates corresponding to specific predefined styles, effects and/or sounds.

The mobile terminal 150 includes an audio signal transmitter 156 that may be configured to transmit the audio signal to, for example, an audio signal rendering device 160. In some embodiments, the audio signal transmitter 156 may include and/or be used in conjunction with a speaker 159 that is located in the mobile terminal 150. The audio signal rendering device 160 may include a variety of audio capable devices including other mobile terminals, stationary terminals, audio amplifiers, network devices and/or storage devices, among others. In this manner, the mobile terminal 150 can receive the audio signal from the musical instrument 10, modify the audio signal and transmit the audio signal via a speaker 159 and/or an external audio signal rendering device 160.

Reference is now made to FIG. 5, which is a block diagram illustrating a mobile terminal using wireless communications for augmenting a musical instrument in accordance with some embodiments of the present invention. In some embodiments, a mobile terminal 170 may include an audio signal receiver 172 that is configured to receive an audio signal from a musical instrument 10. In some embodiments, the audio signal receiver 172 may wirelessly receive the audio signal from the musical instrument 10 by virtue of a wireless signal converter/transmitter that may be attached and/or connected to the musical instrument 10. In some embodiments, the audio signal may be wirelessly received using short range radio frequency methods and/or devices including, for example, Wifi, and/or Bluetooth, among others. In some embodiments, the audio signal may be wirelessly received using medium and/or long range wireless methods and/or devices including, for example, any of a variety of cellular telecommunications protocols, among others.

The mobile terminal 170 may include a signal processor 174 that may modify and/or convert the received audio signal. In some embodiments, the audio signal may be modified and/or converted in form and/or format for a variety of subsequent uses. For example, the audio signal may be modified for storage in one or more data storage locations. In some embodiments, the signal processor 174 may apply a special audio effect to the audio signal. For example, the pitch (frequency) and/or start and/or stop times of one or more notes in the audio signal may be modified. In this manner, the signal processor 174 may improve the tuning and/or timing of the musical content in the audio signal. For example, the signal processor 174 may be configured to modify at least one frequency of a portion of the audio signal corresponding to a defined musical notation system. In some embodiments, a defined musical notation system may include notes corresponding to a scale, which is a group of musical notes that provides material for part or all of a musical work. Scales may be ordered in pitch or pitch class, with their ordering providing a measure of musical distance.

In some embodiments, audio effects such as, for example, reverberation and/or vibrato, among others may be applied. In some embodiments, the audio signal may be modified and/or supplemented to include audio effects such as harmonics, noise and/or signal distortion components. In this manner, the audio signal may be modified to mimic styles and/or sounds of, for example, music played by other musicians. In some embodiments, the signal processor 174 may include modification templates corresponding to specific predefined styles, effects and/or sounds. In some embodiments, the signal processor 174 may be configured to perform an equalizing function that may be configured to adjust multiple relative gain levels corresponding to different audible frequency bands. In some embodiments, a mobile terminal 170 may also include a display that is configured to display a user interface corresponding to augmenting the musical instrument.

The mobile terminal 170 includes an audio signal transmitter 176 that may be configured to wirelessly transmit the audio signal to, for example, an audio signal rendering device 178. In some embodiments, the audio signal transmitter 176 may include and/or be used in conjunction with a speaker (not shown) that is located in the mobile terminal 170. The audio signal rendering device 178 may include a variety of audio capable devices including other mobile terminals, stationary terminals, audio amplifiers, network devices and/or storage devices, among others. In this manner, the mobile terminal 170 can wirelessly receive the audio signal from the musical instrument 10, modify the audio signal and wirelessly transmit the audio signal via an externally configured audio signal rendering device 178.

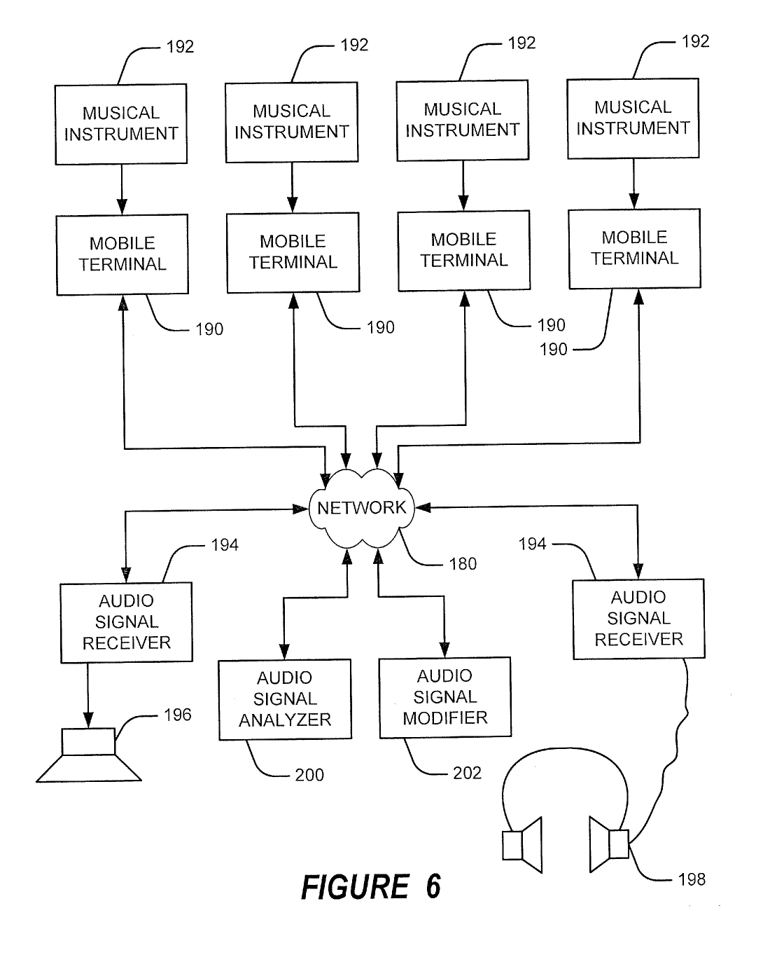

Reference is now made to FIG. 6, which is a block diagram illustrating a network of mobile terminals for cooperatively combining musical instruments in accordance with some embodiments of the present invention. Multiple mobile terminals 190 may receive audio signals from corresponding musical instruments 192. Each of the mobile terminals 190 may be communicatively coupled to one another and/or other network devices via a network 180. For example, the network 180 may be communicatively coupled to other types of devices including audio signal receivers 194, audio signal analyzers 200 and/or audio signal modifiers 202.

In some embodiments, the audio signals sent from each mobile terminal 190 may be received by every other mobile terminal 190. Some embodiments provide that the audio signals may be combined to generate a composite audio signal. In some embodiments, the audio signals may be combined in each of the mobile terminals 190. At least one of the mobile terminals 190 may be configured to selectively isolate, combine and/or modify any of the received audio signals. In this manner, each mobile terminal 190 may be able to generate a composite audio signal. A mobile terminal 190 may be configured to transmit any of the received audio signals and/or the composite signal to an audio signal receiving device (not shown) that is proximate the mobile terminal 190.

In some embodiments, any of the received audio signals and/or the composite audio signal may be received by an audio signal receiver 194 via the network 180. In this manner, the audio signal receiver 194 may drive an audio output device 196 to render any of the received audio signals and/or the composite audio signal. In some embodiments, an audio signal receiver may be configured to selectively provide audio signals via a personal audio output device 198 such as, for example, headphones and/or ear buds, among others.

In some embodiments, the audio signals may be received by an audio signal analyzer 200 that may be configured to analyze one or more of the audio signals. In some embodiments, the signal analyzer 200 may determine one or more characteristics corresponding to the composite audio signal. For example, the composite audio signal may include a general tuning and/or frequency band corresponding to conventional musical notation. The signal analyzer may determine the tuning of the composite audio signal and then compare each of the individual audio signals to the determined tuning characteristic. Similarly, the signal analyzer may determine music timing, tempo and/or style characteristics and make similar comparisons between the composite audio signal and the individual audio signals. In this manner, an individual audio signal corresponding to a specific musical instrument 192 may be identified as outside a normal range of deviation relative to the other musical instruments 192.

In some embodiments, an audio signal modifier 202 may receive the audio signals and/or the composite audio signal via the network 180. In some embodiments, the audio signal modifier 202 may receive data generated by the audio signal analyzer 200 via the network 180. In this manner, the audio signal modifier 202 may be configured to adjust one or more characteristics of any of the audio signals and/or the composite audio signal. For example, if one of the musical instruments 192 is out of tune relative to other of the musical instruments 192, the audio signal modifier 202 may adjust frequencies of the out-of-tune musical instrument 192 to be in tune relative to the other musical instruments 192. In some embodiments, the audio signal modifier 202 may be configured to adjust the relative gains of the individual audio signals in a mixing function. For example, adjusting relative gains may be desirable in embodiments where the musical instruments include different types of instruments.

An audio signal analyzer 200, audio signal modifier 202 and/or audio signal receiver 194 may include distinct devices and/or be integrated into combined devices that incorporate some or all of the functions therein. In some embodiments, the mobile terminal 190 may include functionality corresponding to the audio signal analyzer 200 and/or the audio signal modifier 202.

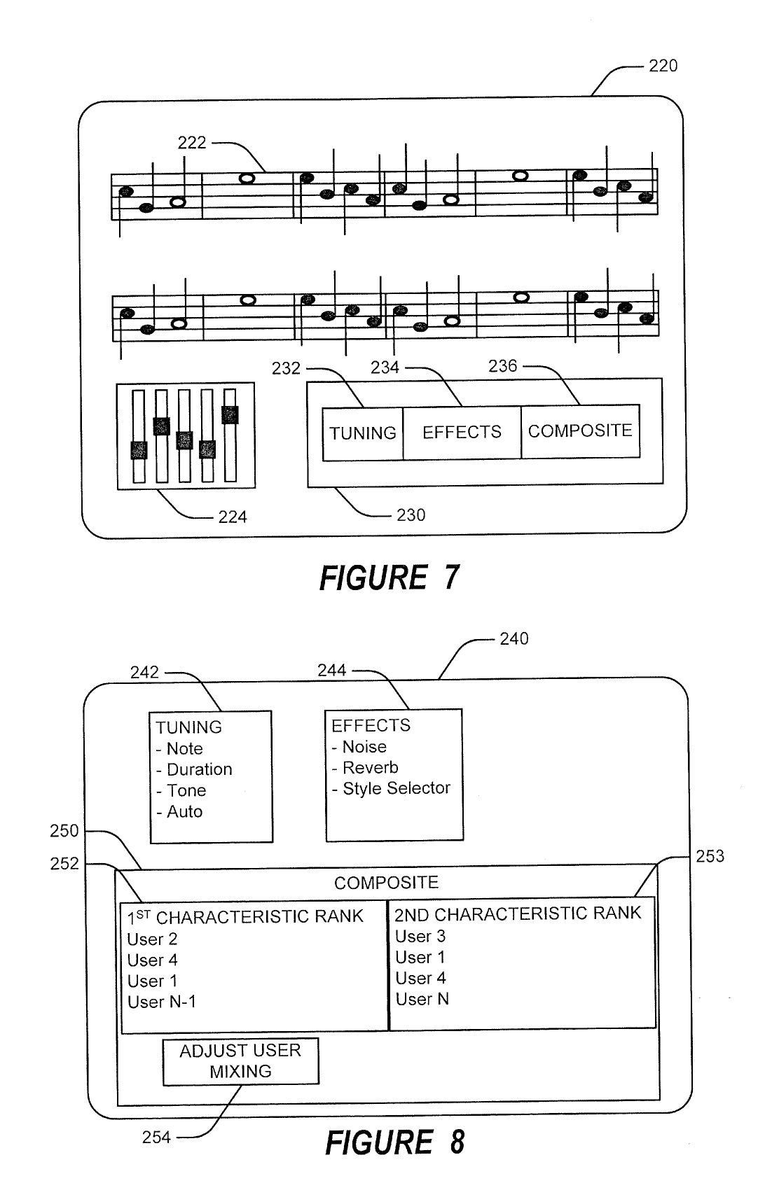

Reference is now made to FIG. 7, which is a block diagram illustrating a display of a mobile terminal that is used for augmenting a musical instrument in accordance with some embodiments of the present invention. In some embodiments, a display 220 may be configured to display a user interface corresponding to augmenting the musical instrument. Some embodiments of a user interface may include an equalizing function interface 224 that allows a user to adjust relative gain levels corresponding to multiple audible frequency bands. For example, a user may use the equalizer function to compensate for effects corresponding to system devices such as speakers and/or environmental conditions such as acoustic properties in a room.

A user interface may be configured to display musical notation 222 corresponding to music that is determined from a received audio signal. In this regard, mobile terminal may receive an audio signal corresponding to music played by a user and the user interface may display the musical notation 222 responsive to the audio signal. In some embodiments, a mobile terminal may include an audio analyzer that analyzes the audio content of the audio signal and generates corresponding musical notation 222.

In some embodiments, a user interface may display musical notation 222 for a user to read and play on the musical instrument. In this regard, the audio signal may correspond to the displayed musical notation 222, depending, for example, on the skill of the user. In some embodiments, a signal processor within a mobile terminal may modify an audio signal to more comport with the displayed musical notation 222.

A user interface may include an audio signal modification controller 230 that provides a user with controls for modifying one or more received and/or composite audio signals. For example, an audio signal modification controller may include control interfaces corresponding to tuning functions 232, audio effects functions 234 and/or composite signal modification functions 236, among others.

Reference is now made to FIG. 8, which is a block diagram illustrating a display of a mobile terminal that includes functions for cooperatively combining musical instruments in accordance with some embodiments of the present invention. An audio signal modification controller 240 may include a tuning interface 242. In some embodiments, the tuning interface 242 may be used to generate a tuning note that may be used as a reference for tuning musical instruments. The duration of the tuning note may be adjustable via the tuning interface 242. In some embodiments, a tuning note may be selected and an audio signal corresponding to that note may be played on the musical instrument and received in the mobile terminal. The frequency of the received audio signal may be compared to the frequency of the tuning note and tuning instructions may be provided to the user for a device assisted tuning. In some embodiments, an automatic tuning function may be selected wherein the audio signal is tuned within the mobile terminal such that regardless of the tuning of a received audio signal, a transmitted audio signal is tuned according to, for example, some standard musical notation system.

In some embodiments, an audio signal modification controller 240 may include an audio effects interface 244. In some embodiments, the audio effects interface 244 may allow a user to modify an audio signal using audio effects including noise, reverberation, harmonics, vibrato and/or predefined audio styles, among others. For example, an audio signal may be modified to include audio effects consistent with styles and/or sounds associated with specific artists, eras, technologies and/or venues, among others.

In some embodiments, an audio signal modification controller 240 may include the composite signal modification interface 250. In some embodiments, the composite signal modification interface 250 may include an adjust user mixing interface 254 for adjusting relative gains of one or more audio signals that may be combined as a composite audio signal. The composite signal modification interface 250 may also be configured to provide first characteristic rank data 252 corresponding to how multiple users are ranked relative to one another in terms of a first characteristic. For example, a first characteristic may include pitch and/or frequency control relative to the composite audio signal.

In this regard, a user producing an audio signal with minimal pitch deviation relative to other users may be ranked highly, whereas the user producing audio signals that are substantially out of tune may be ranked at a low position relative to the other users.

Similarly, the composite signal modification interface 250 may include second characteristic rank data 253 corresponding to how multiple users are ranked relative to one another in terms of a second characteristic. For example, a second characteristic may include timing and/or tempo control relative to the composite audio signal.

In this regard, a user producing an audio signal with minimal timing/tempo deviation relative to other users may be ranked highly, whereas the user producing audio signals are substantially out of time/tempo may be ranked at a low position relative to the other users. By providing relative user data corresponding to multiple characteristics, the composite audio signal may be improved through adjustments made to audio signals exhibiting the greatest deviations from the composite audio signal. In some embodiments, audio signals that exhibit significant deviations and thus may detract from the quality of the composite audio signal may be eliminated from the composite audio signal.

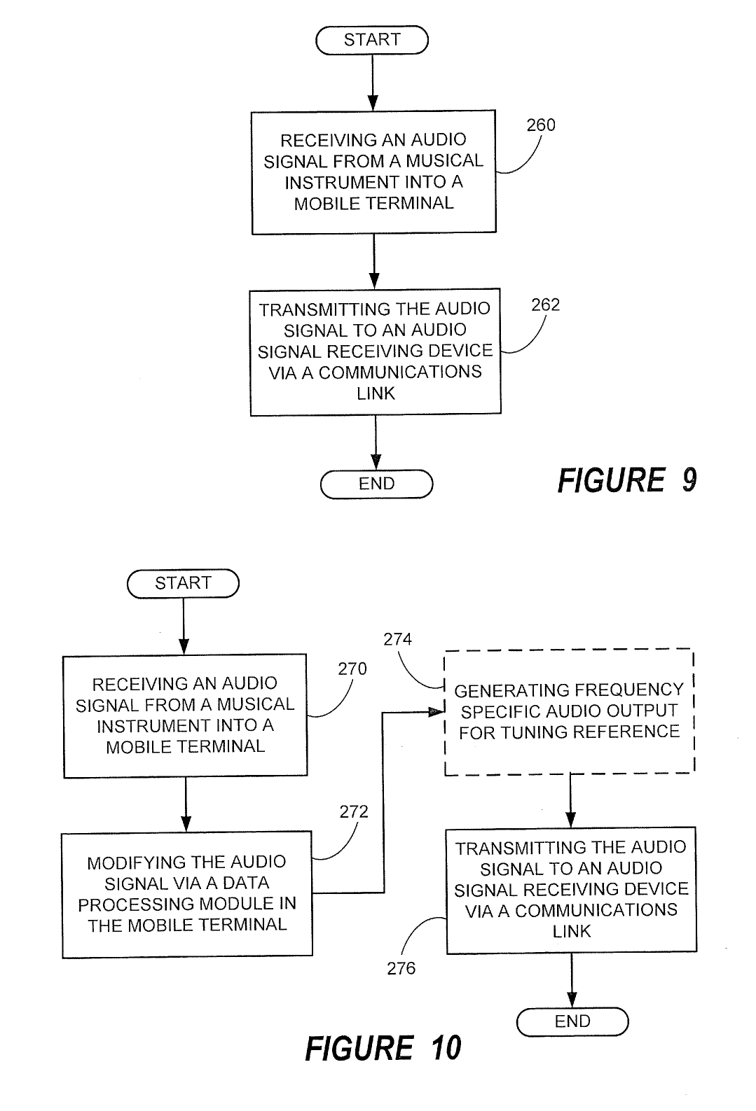

Reference is now made to FIG. 9, which is a flow diagram illustrating operations for augmenting a musical instrument using a mobile communications terminal in accordance with some embodiments of the present invention. An audio signal may be received into a mobile terminal from a musical instrument (block 260). In some embodiments, receiving the audio signal may include receiving acoustic energy into a microphone located in the mobile terminal. In some embodiments, the audio signal may be received as an analog and/or digital audio signal by a signal generator that may be coupled to the musical instrument and configured to convert acoustic energy generated by the musical instrument into the analog and/or digital audio signal. In some embodiments, receiving the audio signal may also include converting an analog audio signal into a digital audio signal.

Augmenting the musical instrument using a mobile terminal may also include transmitting the audio signal to an audio signal receiving device via a communications link (block 262). In some embodiments, transmitting the audio signal includes transmitting via a wireless communications link. In some embodiments, the audio signal may be transmitted to an audio output device that is configured to output the audio signal. Some embodiments provide that the audio output device includes one or more speakers connected to a audio signal amplifier, such as, for example, a conventional stereo system. In this manner, an audio signal generated by a musical instrument can be transmitted to an audio signal receiving device via a communications link using a mobile terminal.

Reference is now made to FIG. 10, which is a flow diagram illustrating operations for augmenting a musical instrument using a mobile communications terminal in accordance with some embodiments of the present invention. An audio signal may be received into a mobile terminal from a musical instrument (block 270). In some embodiments, receiving the audio signal may include receiving acoustic energy into a microphone located in the mobile terminal. In some embodiments, the audio signal may be received as an analog and/or digital audio signal by a signal generator that may be coupled to the musical instrument and configured to convert acoustic energy generated by the musical instrument into the analog and/or digital audio signal. In some embodiments, receiving the audio signal may also include converting an analog audio signal into a digital audio signal.

The audio signal received by the mobile terminal may be modified via a data processing module in the mobile terminal (block 272). In some embodiments, modifying the audio signal may include applying a special audio effect to the audio signal. For example, special audio effects including noise, reverberation, harmonics, vibrato and/or predefined audio styles, among others may be applied to the audio signal. In some embodiments, modifying the audio signal may include adjusting the frequency of the audio signal. For example, adjusting a frequency may improve the pitch tuning relative to frequencies that may be used in musical notation systems.

In some embodiments, an optional operation of generating a frequency specific audio output that is configured to provide a tuning reference tone may be provided (block 274). In this manner, the user of a musical instrument may tune the instrument using one or more reference tones generated by the mobile terminal. In some embodiments, a tuning reference value may be internally generated corresponding to a specific frequency and a designated component of the audio signal may be compared to the tuning reference value to determine a tuning state of the musical instrument. Tuning information corresponding to the tuning state may then be communicated to the user. For example, a user may be prompted to play one or more notes corresponding to a musical notation system. The frequency of the notes, which may be received as an audio signal, may be compared to the tuning reference value and the user may be provided tuning information regarding the instrument. For example, where the pitch of a note from musical instrument is higher than the tuning reference value, the user may be provided information indicating that the musical instrument is sharp relative to the tuning reference value.

Augmenting the musical instrument using a mobile terminal may also include transmitting the audio signal to an audio signal receiving device via a communications link (block 276). In some embodiments, transmitting the audio signal includes transmitting via a wireless communications link. In some embodiments, the audio signal may be transmitted to an audio output device that is configured to output the audio signal. Some embodiments provide that the audio output device includes one or more speakers connected to a audio signal amplifier. In this manner, an audio signal generated by a musical instrument may be transmitted to an audio signal receiving device via a communications link using a mobile terminal.

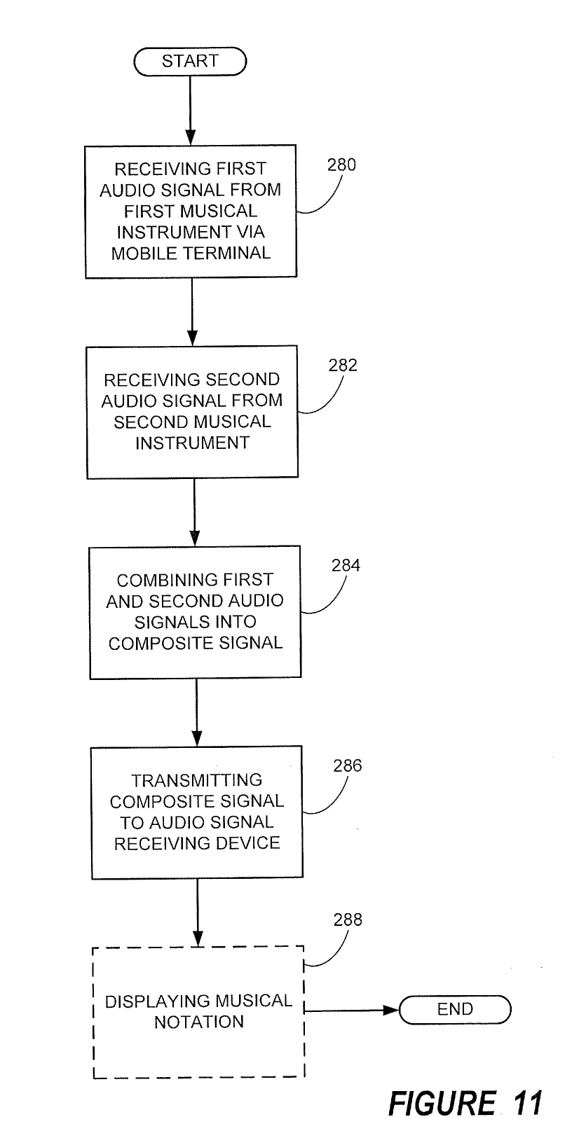

Reference is now made to FIG. 11, which is a flow diagram illustrating operations for cooperatively combining outputs from musical instruments via a mobile communications terminal in accordance with some embodiments of the present invention. Cooperatively combining outputs from musical instruments via a mobile terminal includes receiving a first audio signal into a signal processing device from a first musical instrument via a first mobile communications terminal (block 280). In some embodiments, the first musical instrument may be proximate the first mobile terminal. In some embodiments, the first audio signal may be wirelessly received into the signal processing device. For example, some embodiments provide that the first audio signal may be received from a long range wireless transmitter.

Cooperatively combining outputs from musical instruments via a mobile terminal may include receiving a second audio signal from a second musical instrument into the signal processing device (block 282). In some embodiments, the second musical instrument may be proximate the signal processing device. In some embodiments, the signal processing device may be a second mobile terminal that is configured to receive the second audio signal from the second musical instrument.

Operations may include combining the first audio signal and the second audio signal into a composite audio signal (block 284). For example, the first audio signal may correspond to music generated by a guitar proximate the first mobile terminal at a first location and the second audio signal may correspond to music generated by a piano proximate the signal processing device at a second location. In this regard, the composite audio signal may include coordinated music of the guitar and piano that are generated at different locations from one another.

Cooperatively combining musical instruments via a mobile terminal may include transmitting the composite signal to an audio signal receiving device (block 286). An audio signal receiving device may be configured to receive the composite signal via long, medium and/or short range wired and/or wireless communication. In some embodiments, the audio signal receiving device may drive an audio output device to render the composite audio signal. In some embodiments, an audio signal receiving device may be configured to selectively provide audio signals via one or more personal audio output devices such as, for example, headphones and/or ear buds, among others. In some embodiments, the audio signal receiving device may be configured to store, broadcast and/or analyze the composite signal and/or components thereof. For example, some embodiments may include broadcasting the composite audio signal via a network to multiple audio output devices.

Further exemplary operations for cooperatively combining musical instruments via a mobile terminal may include displaying musical notation (block 288). In some embodiments, the musical notation may correspond to music that is to be played by one or more of the musical instruments. In some embodiments, the musical notation may correspond to one or more audio signals and/or the composite signal. In this regard, some embodiments may include generating the played musical notation responsive to the received and/or composite audio signals.

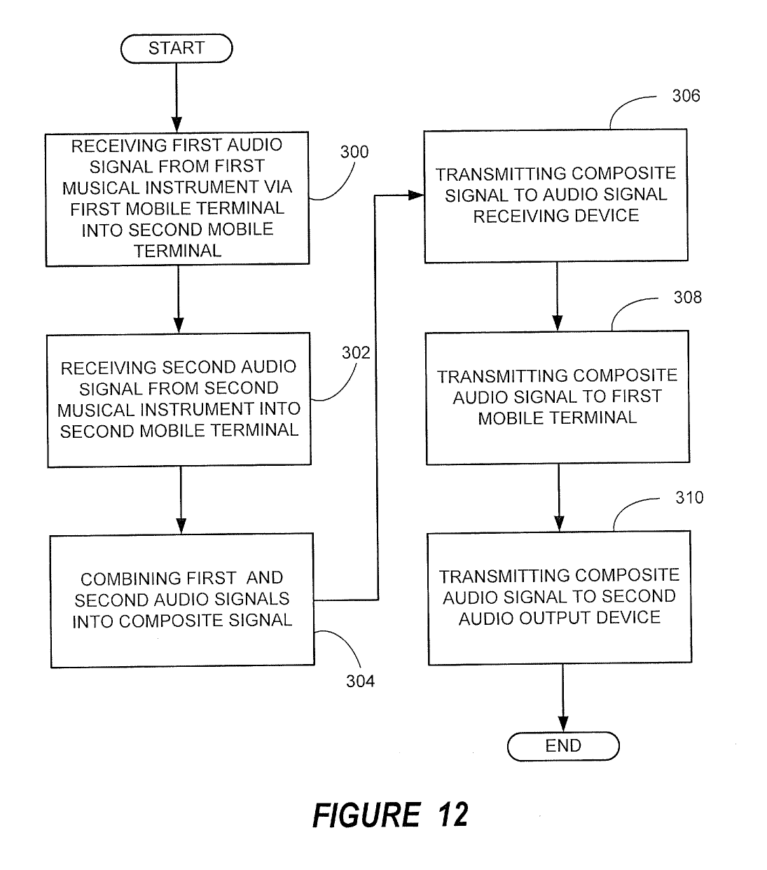

Reference is now made to FIG. 12, which is a flow diagram illustrating operations for cooperatively combining outputs from musical instruments via a mobile communications terminal in accordance with some embodiments of the present invention. Cooperatively combining outputs from musical instruments via a mobile terminal may include receiving a first audio signal from a first musical instrument via a first mobile communications terminal into a second mobile terminal (block 300). In some embodiments, the first musical instrument may be proximate the first mobile terminal. In some embodiments, the first audio signal may be wirelessly received into the second mobile terminal. For example, some embodiments provide that the first audio signal may be received from a long range wireless transmitter.

Cooperatively combining outputs from musical instruments via a mobile terminal may include receiving a second audio signal from a second musical instrument into the second mobile terminal (block 302). In some embodiments, the second musical instrument may be proximate the second mobile terminal. In some embodiments, the second mobile terminal may receive the second audio signal via a third mobile terminal.

Operations may include combining the first audio signal and the second audio signal into a composite audio signal (block 304). For example, the first audio signal may correspond to music generated by a guitar proximate the first mobile terminal at a first location and the second audio signal may correspond to music generated by a piano proximate the second mobile terminal at a second location.

Cooperatively combining musical instruments via a mobile terminal may include transmitting the composite signal to an audio signal receiving device (block 306). An audio signal receiving device may be configured to receive the composite signal via long, medium and/or short range wired and/or wireless communication. In some embodiments, the audio signal receiving device may drive an audio output device to render the composite audio signal. In some embodiments, an audio signal receiving device may be configured to selectively provide audio signals via one or more personal audio output devices such as, for example, headphones and/or ear buds, among others. In some embodiments, the audio signal receiving device may be configured to store, broadcast and/or analyze the composite signal and/or components thereof. For example, some embodiments may include broadcasting the composite audio signal via a network to multiple audio output devices.

In some embodiments, the composite audio signal may be transmitted to the first mobile terminal (block 308). The composite audio signal may be transmitted from the first mobile terminal to a first audio output device that is proximate the first mobile terminal. In some embodiments, the composite audio signal may be transmitted to a second audio output device (block 310). For example, some embodiments may provide for transmission of the composite audio signal from the second mobile terminal to the second audio output device that is proximate the second mobile terminal.

Operations may include modifying either of the first or second audio signals responsive to another of the first or second audio signals before combining the first audio signal and the second audio signal. For example, one of the audio signals may be modified to be in tune, time and/or tempo with the other audio signal before the composite audio signal is generated. In some embodiments, modifying the first and/or second audio signals may be responsive to user inputs received at the first and/or second mobile terminals.

In some embodiments, one of the first or second mobile terminals may be designated as a master terminal relative to the other of the mobile terminals. In some embodiments, the master terminal may generate a timing signal that may communicate a tempo to the other mobile terminal. In this manner, the audio signal corresponding to the non-master terminal may be synchronized with the audio signal corresponding to the master terminal. In some embodiments, the timing signal may be a periodically emitted tone akin to, for example, a metronome. A timing signal of some embodiments may provide visual indication of the tempo and/or timing.

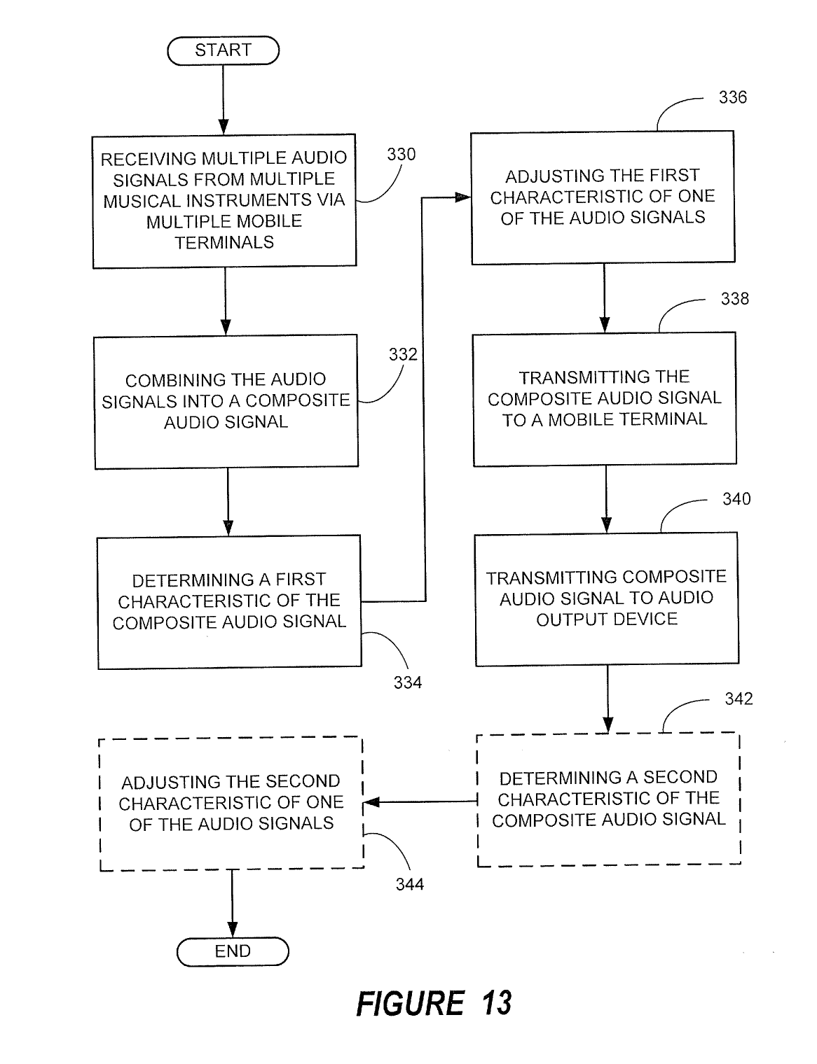

Reference is now made to FIG. 13, which is a flow diagram illustrating operations for forming a musician group using mobile communications terminals in accordance with some embodiments of the present invention. Operations for forming a musician group may include receiving multiple audio signals from multiple musical instruments via multiple mobile terminals (block 330). In some embodiments, the multiple audio signals may be received into one of the mobile terminals. In some embodiments, the multiple audio signals may be received by a one or more stationary and/or mobile terminals and/or audio signal receiving devices.

The multiple audio signals may be combined into a composite signal (block 332). Combining the multiple audio signals may include using a variety of mixing, audio signal gains, audio effects and/or modifications that may be applied at any of the devices and/or terminals that are configured to receive the multiple audio signals. For example, in some embodiments, one or more distinct composite signals may be generated from the same set of received audio signals.

A first characteristic of the composite signal may be determined (block 334). In some embodiments, determining the first characteristic may include determining a first characteristic range that includes a first upper limit and a first lower limit. Examples of a first characteristic may include tuning, timing, tone quality, and/or musical notation adherence, among others. For example, in some embodiments, the first characteristic may include audible frequency.

The first characteristic of at least one of the multiple audio signals may be adjusted relative to the first characteristic of the composite audio signal (block 336). In some embodiments, adjusting the first characteristic may include adjusting ones of the multiple audio signals that contain a first characteristic value that is greater than the first upper limit and/or less than the first lower limit.

The composite audio signal may be transmitted to at least one of the mobile terminals (block 338). In this manner, the mobile terminals may render, play, store, modify and/or analyze the composite audio signal. In some embodiments, the composite audio signal may be transmitted to an audio output device (block 340). In this regard, the composite audio signal may be received by users regardless of their proximity to one or more of the musical instruments.

Some embodiments may optionally include determining a second characteristic of the composite audio signal (block 340). In this regard, the second characteristic may be different from the first characteristic and may be used to further distinguish between the multiple audio signals. For example, where the first characteristic is frequency, the second characteristic may include timing and/or tempo, among others.

Operations may further include adjusting the second characteristic of one or more of the multiple audio signals relative to the second characteristic of the composite audio signal (block 344). For example, the timing and/or tempo of one of the audio signals may be adjusted to better comport with the timing and/or tempo of the composite audio signal. In this manner, by adjusting one or more characteristics of one or more of the multiple audio signals according to characteristics of the composite audio signal, the composite audio signal may improve.

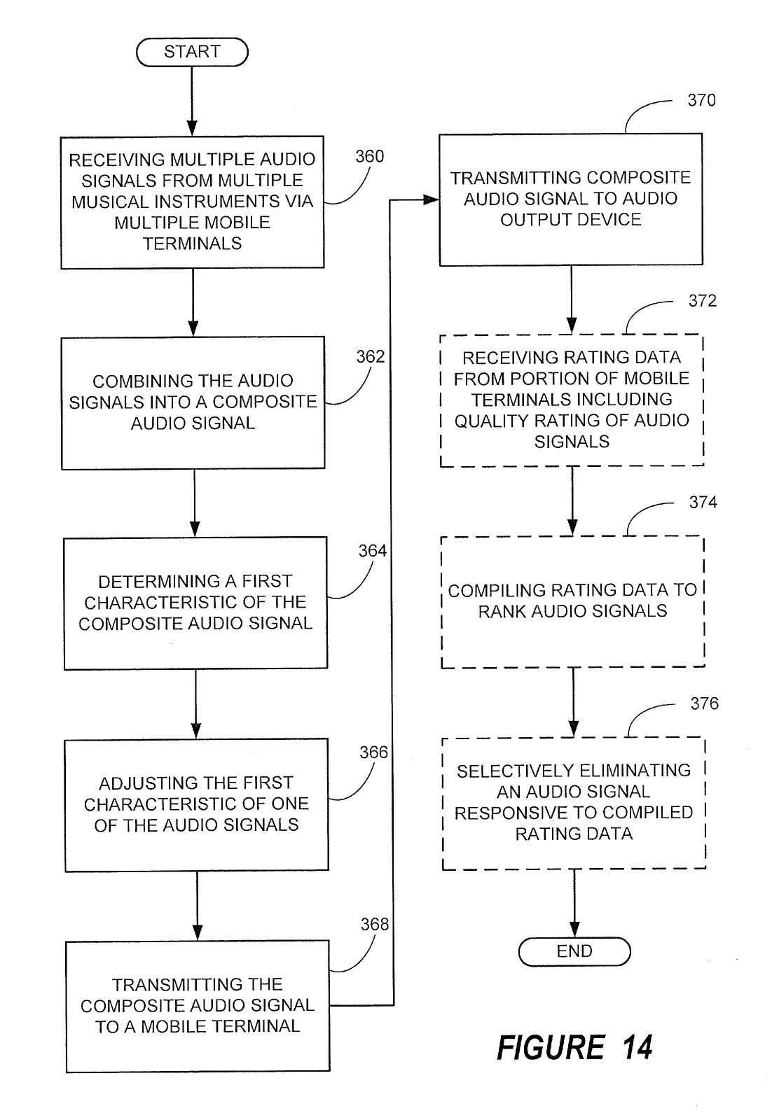

Reference is now made to FIG. 14, which is a flow diagram illustrating operations for forming a musician group using mobile communications terminals in accordance with some embodiments of the present invention. Operations for forming a musician group may include receiving multiple audio signals from multiple musical instruments via multiple mobile terminals (block 360). In some embodiments, the multiple audio signals may be received into one of the mobile terminals. In some embodiments, the multiple audio signals may be received by a one or more stationary and/or mobile terminals and/or audio signal receiving devices.

The multiple audio signals may be combined into a composite signal (block 362). Combining multiple audio signals may include using a variety of mixing, audio signal gains, audio effects and/or modifications that may be applied at any of the devices and/or terminals that are configured to receive the multiple audio signals. For example, in some embodiments, one or more distinct composite signals may be generated from the same set of received audio signals.

A first characteristic of the composite signal may be determined (block 364). In some embodiments, determining the first characteristic may include determining a first characteristic range that includes a first upper limit and a first lower limit. Examples of a first characteristic may include tuning, timing, tone quality, and/or musical notation accuracy, among others. For example, in some embodiments, the first characteristic may include frequency.

The first characteristic of at least one of the multiple audio signals may be adjusted relative to the first characteristic of the composite audio signal (block 366). In some embodiments, adjusting the first characteristic may include adjusting ones of the multiple audio signals that contain a first characteristic value that is greater than the first upper limit and/or less than the first lower limit.

The composite audio signal may be transmitted to at least one of the mobile terminals (block 368). In this manner, the mobile terminals may play, store, modify and/or analyze the composite audio signal. In some embodiments, the composite audio signal may be transmitted to an audio output device (block 370). In this regard, the composite audio signal may be received by users regardless of their proximity to one or more of the musical instruments.

Some embodiments may optionally include receiving rating data from a portion of the mobile terminals such that the rating data includes a quality rating of at least one of the multiple audio signals (block 372). In this manner, individual audio signals may be rated in terms of performance, quality, contribution and/or merit using a variety of objective and/or subjective characteristics. The rating data may optionally be compiled to rank the multiple audio signals (block 374). In this manner, the relative merits corresponding to the multiple audio signals may be compared. In some embodiments, the rating data may be compiled specific to any of a variety of performance characteristics, classifications and/or categories.

Some embodiments may optionally include selectively eliminating an audio signal responsive to the compiled rating data (block 376). For example, an audio signal that corresponds to a low-quality and/or less desirable musical performance may be eliminated such that the overall quality and/or desirability of the composite audio signal may be improved. In some embodiments, the selective elimination may be performed within any of the mobile terminals used to transmit the audio signals. In some embodiments, one or more non-transmitting terminals may be used to perform the selective elimination. For example, the operations herein may be utilized to receive audio signals from a large number of participants in a contest directed towards selecting musicians. In some embodiments, the selective elimination may be performed by one or more judges and/or by viewers and/or spectators. In some embodiments, the selective elimination may be limited to peers who are also submitting audio signals.

As will be appreciated by one of skill in the art, the present invention may be embodied as a method, device or system. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described above with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of augmenting a musical instrument via a mobile communications terminal, the method comprising:
receiving an audio signal from the musical instrument into a mobile communications terminal that includes telecommunications circuitry; and
transmitting the audio signal to an audio signal receiving device via a communications link.

2. The method of claim 1, wherein receiving the audio signal comprises receiving the audio signal into a microphone in the mobile communications terminal and wherein transmitting the audio signal comprises transmitting the audio signal via a wireless communications link.

3. The method of claim 1, wherein receiving the audio signal comprises:
receiving an analog audio signal via a signal generator that is coupled to the musical instrument and configured to convert acoustic energy generated by the musical instrument into the analog audio signal; and
converting the analog audio signal into a digitized audio signal.

4. The method of claim 1, before transmitting the audio signal, further comprising modifying the audio signal via a data processing module in the mobile communications terminal.

5. The method of claim 4, wherein modifying the audio signal comprises applying an audio effect to the audio signal.

6. The method of claim 4, wherein modifying the audio signal comprises adjusting a frequency of the audio signal.

7. The method of claim 1, further comprising generating a frequency specific audio output that is configured to provide a tuning reference tone for tuning the musical instrument.

8. The method of claim 1, wherein transmitting the audio signal to an audio signal receiving device comprises transmitting the audio signal to an audio output device that is configured to output the audio signal.

9. The method of claim 8, wherein transmitting the audio signal to an audio output device comprises transmitting the audio signal to one or more speakers via an audio signal amplifier.

10. The method of claim 1, further comprising:
internally generating a tuning reference value corresponding to a specific frequency;
comparing a designated component of the audio signal to the tuning reference value to determine a tuning state of the musical instrument; and
communicating tuning information to a user corresponding to the tuning state.

11. A mobile communications terminal for augmenting a musical instrument, the terminal comprising:
an audio signal receiver that is configured to receive an audio signal from the musical instrument;
a signal processor that is configured to perform a signal processing function on the audio signal; and
an audio signal transmitter that is configured to transmit the audio signal to an audio signal rendering device.

12. The mobile communications terminal of claim 11, wherein the audio signal rendering device comprises at least one audio speaker.

13. The mobile communications terminal of claim 11, wherein the audio signal transmitter comprises a wireless transmitter that is configured to wirelessly transmit the audio signal to the audio signal rendering device.

14. The mobile communications terminal of claim 11, wherein the signal processing function comprises a modification of at least one frequency of the audio signal corresponding to a defined musical notation system.

15. The mobile communications terminal of claim 11, wherein the signal processing function comprises an audio effect that is configured to alter and/or supplement a waveform of the audio signal.

16. The mobile communications terminal of claim 11, wherein the signal processing function comprises an equalizing function that is configured to adjust a plurality of relative gain levels corresponding to a plurality of frequency bands.

17. The mobile communications terminal of claim 11, further comprising a display that is configured to display a user interface corresponding to augmenting the musical instrument.

18. The mobile communications terminal of claim 17, wherein the user interface is further configured to display musical notation corresponding to music that is configured to be played on the first instrument.

19. The mobile communications terminal of claim 17, wherein the user interface is further configured to display played musical notation responsive to the audio signal.

20. The mobile communications terminal of claim 11, further comprising an audio signal analyzer that is configured to analyze the audio signal and generate musical notation data corresponding to the audio signal.

21. The mobile communications terminal of claim 11, further comprising:
a remote audio signal receiver that is configured to receive a remote audio signal corresponding to a remotely located musical instrument; and
an audio signal combiner that is configured to combine the audio signal and the remote audio signal to generate a composite audio signal,
wherein the audio signal transmitter is configured to transmit the composite audio signal.

22. The mobile communications terminal of claim 11, wherein the audio signal receiver comprises a microphone that is configured to receive the audio signal via acoustic energy generated by the musical instrument.

23. A method of cooperatively combining outputs from musical instruments via a mobile communications terminal, the method comprising:
wirelessly receiving a first audio signal into a signal processing device from a first musical instrument via a first mobile communications terminal using a first communications link;
receiving a second audio signal from a second musical instrument into the signal processing device;
combining the first audio signal and the second audio signal into a composite audio signal; and
transmitting the composite audio signal to an audio signal receiving device via a second communications link.

24. A method of forming a musician group using mobile communications terminals, the method comprising:
receiving a plurality of audio signals from a plurality of instruments via a plurality of mobile communications terminals;
combining the plurality of audio signals into a composite audio signal;
determining a first characteristic of the composite audio signal;
adjusting the first characteristic of at least one of the plurality of audio signals relative to the first characteristic of the composite audio signal; and
transmitting the composite audio signal to at least one of the plurality of mobile communications terminals.
